(19) United States
(12) Patent Application Publication
(10) Pub. No.: US 2025/0067938 A1
(43) Pub. Date: Feb. 27, 2025

(54) INDIVIDUAL GRATING FABRICATION AND ASSEMBLY

(71) Applicant: Applied Materials, Inc., Santa Clara, CA (US)

(72) Inventors: Michael Alexander WEINSTEIN, San Francisco, CA (US); Rutger MEYER TIMMERMAN THIJSSEN, Sunnyvale, CA (US)

(21) Appl. No.: 18/815,133

(22) Filed: Aug. 26, 2024

Related U.S. Application Data
(60) Provisional application No. 63/578,794, filed on Aug. 25, 2023.

(51) Int. Cl. G02B 6/34; G02B 6/02

(52) U.S. Cl. CPC G02B 6/34; G02B 6/02123

(57) ABSTRACT

The present disclosure generally provides waveguide combiners and methods thereof. The methods include forming a waveguide combiner by disposing a first grating including a first device structure over a first donor substrate. The first grating is transferred from the first donor substrate to a waveguide substrate.

### CROSS-REFERENCE TO RELATED APPLICATIONS

This application claims priority to U.S. Provisional Patent Application No. 63/578,794, filed Aug. 25, 2023, the entirety of which is herein incorporated by reference.

### BACKGROUND

### Field

Embodiments described herein generally relate to a waveguide combiner. More specifically, embodiments described herein relate to waveguide gratings and methods of fabricating waveguide combiners.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses that display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. Approaches for producing augmented reality devices include producing waveguide combiners having at least a first grating and a second grating. Notably, however, conventional waveguide fabrication processes commonly implement a process to form a grating on a waveguide substrate, thereby limiting the ability to repair and/or replace the grating due to the integration of the grating on the waveguide substrate. Moreover, by producing a grating on the waveguide substrate an increase in manufacturing costs occurs as well as a limitation on assembly of unique waveguide combiner assembly architectures.

Accordingly, what is needed are improved waveguide manufacturing fabrication processes.

### SUMMARY

In an embodiment, the present disclosure generally provides methods of forming waveguide combiners. The methods include disposing a first grating including a first device structure over a first donor substrate. The first grating is transferred from the first donor substrate to a waveguide substrate.

In another embodiment, the present disclosure generally provides methods forming a waveguide combiners. The methods include disposing a first coating layer over a first donor substrate. A first device structure is disposed over the first coating layer. The first device structure is transferred to a waveguide substrate, in which transferring the first device structure comprises inverting the first donor substrate and disposing the first device structure over the waveguide substrate.

In another embodiment, the present disclosure generally provides waveguide combiners. The waveguide combiners include a substrate. A first grating is disposed over the substrate. The first grating includes a first device structure, and a first coating layer disposed over the first device structure.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a flow diagram of a method for forming a waveguide combiner, according to certain embodiments.

FIG. 2 a schematic, frontal view of a waveguide combiner during a method for forming a waveguide combiner according to certain embodiments.

FIG. 3A is a perspective, frontal view of a waveguide combiner according to embodiments described herein.

FIG. 3B is a schematic, cross-sectional views of a waveguide combiner according to embodiments described herein.

FIG. 3C is a schematic, cross-sectional views of a waveguide combiner according to embodiments described herein.

FIG. 4 is a flow diagram of a method for forming a waveguide combiner, according to certain embodiments.

FIGS. 5A-5M are schematic, cross-sectional views of a portion of a device material during a method for forming a waveguide combiner according to certain embodiments.

FIG. 6 is a flow diagram of a method for forming a waveguide combiner, according to certain embodiments.

FIGS. 7A-7J are schematic, cross-sectional views of a portion of a device material during a method for forming a waveguide combiner according to certain embodiments.

FIGS. 8A and 8B are schematic, frontal views of a first donor substrate according to embodiments described herein.

FIGS. 9A and 9B are schematic, frontal views of a second donor substrate according to embodiments described herein.

FIGS. 10A and 10B are schematic, frontal views of a third donor substrate according to embodiments described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments described herein generally relate to optical devices. More specifically, embodiments described herein relate to waveguide combiners and methods of fabricating and assembling waveguide combiners. In various embodiments, techniques are provided to fabricate waveguide combiners by bonding a first grating from a first donor substrate, e.g., silica, and a second grating from a second donor substrate, e.g., silica, to a waveguide substrate, e.g., glass, thereby allowing for efficient waveguide processing. By individually bonding the first grating from a first donor substrate to a waveguide substrate, a reduction in manufacturing time and costs is achieved. Moreover, individually bonding the first grating from a first donor substrate to a waveguide substrate can allow for complex waveguide combiners and/or non-standard waveguide combiners to be formed, thereby allowing for unique waveguide combiner assembly architectures to be formed. The present disclosure may allow for higher yields waveguide manufacturing, and the creation of curved waveguide devices with the use of specialized carrier substrates. Additionally, a reduction in manufacturing costs may be achieved by individualized repair processes, in which a first grating of a waveguide combiner may be repaired without the need to replace the entire waveguide combiner. While the present disclosure describes a first grating, a second grating, and a third grating, any number of gratings may be disposed on the waveguide combiner.

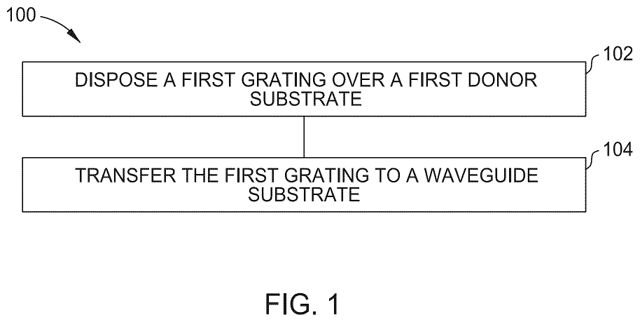

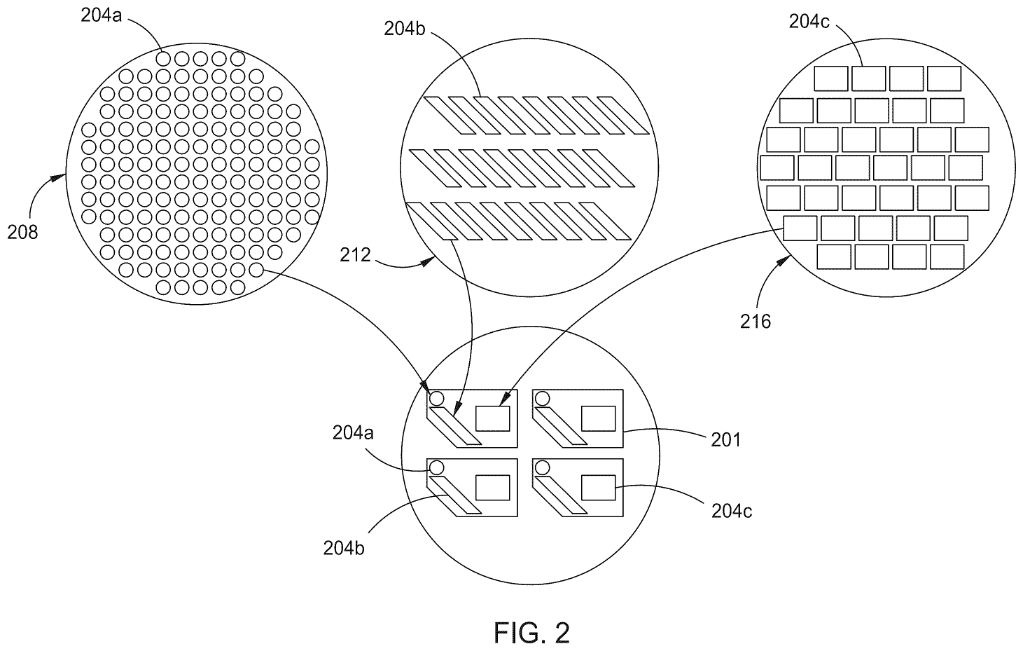

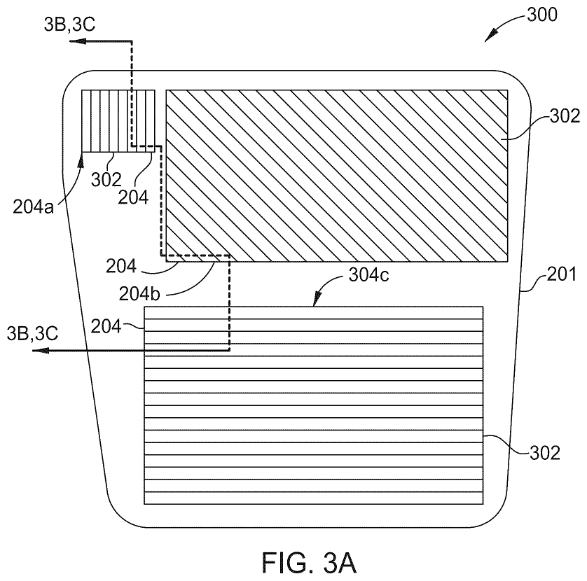

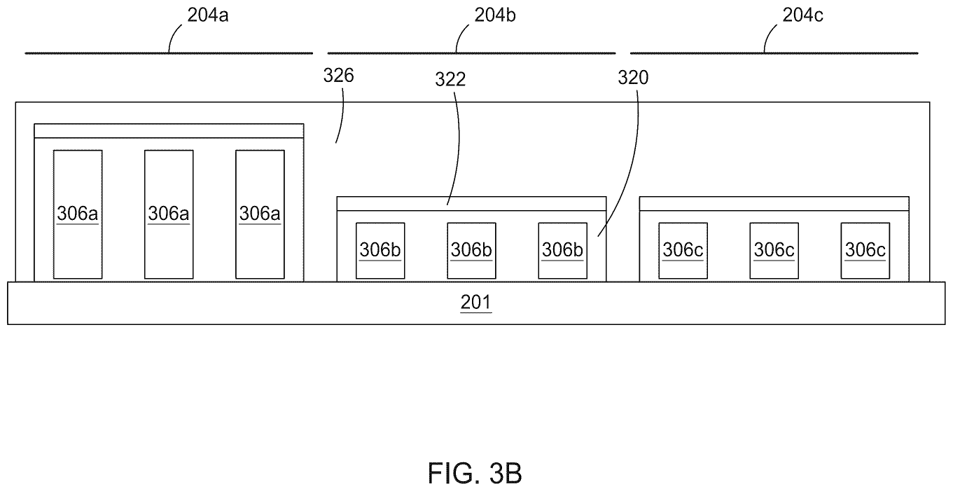

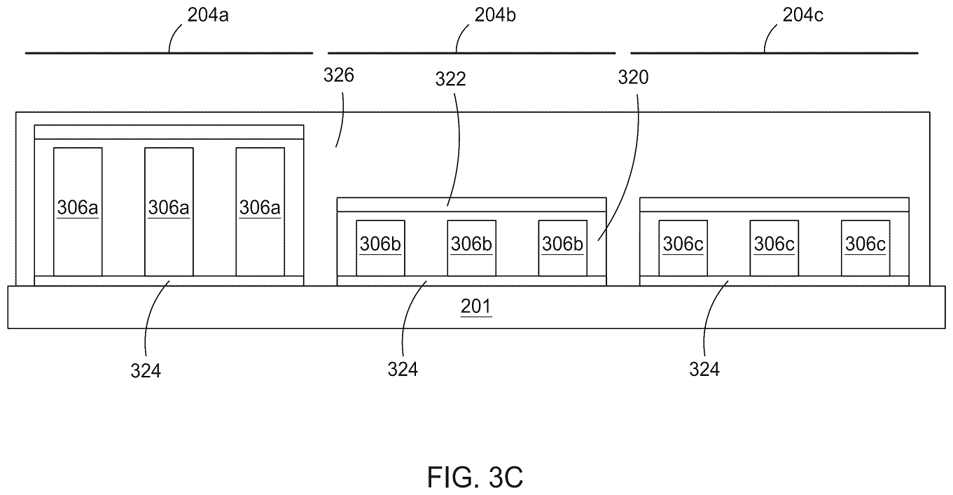

FIG. 1 is a flow diagram of a method 100 for forming a waveguide combiner 200. FIG. 2 shows portions of waveguide combiners corresponding to the method 100. At operation 102, as shown in FIG. 2, a first grating 204a is disposed over a first donor substrate 208. In some embodiments, a plurality of first gratings are disposed over the first donor substrate 208. Each first grating 204a of the plurality of first gratings includes a first device structure, as described below in reference to FIGS. 3A-3C. The first grating 204a is disposed by depositing device material over the first donor substrate 208. The device material is then patterned to form the first grating 204a. The first grating 204a can be deposited via one or more deposition processes, e.g., chemical vapor deposition, physical vapor desorption, plasma enhanced deposition, or a combination thereof. The patterning process to form the first grating 204a includes, but is not limited to, nano-imprint lithography, reactive ion etching, ion beam etching, or combinations thereof. While FIG. 2 shows a first grating 204a, a second grating 204b, and a third grating 204c, the waveguide combiner of the present disclosure can include only a single grating, such as only a first grating 204a, only a second grating 204b, only a third grating 204c, and/or a combination thereof.

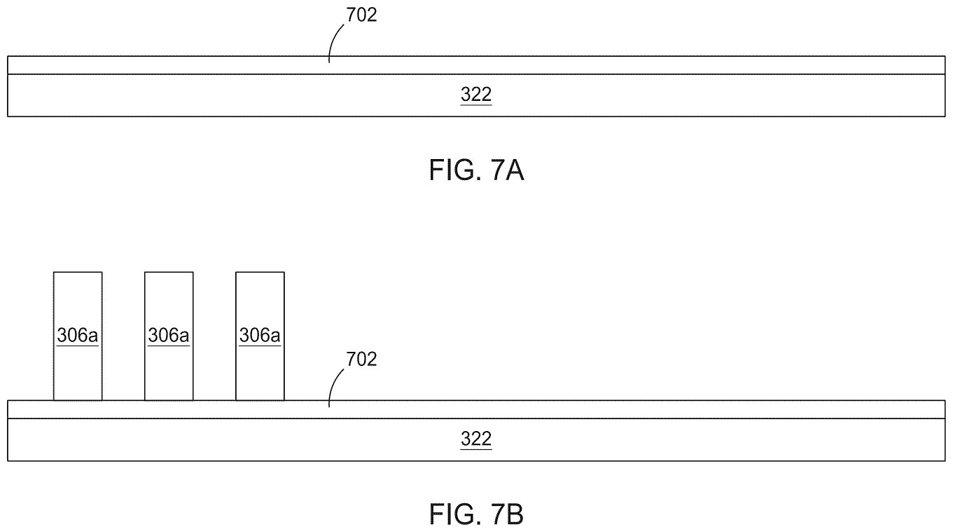

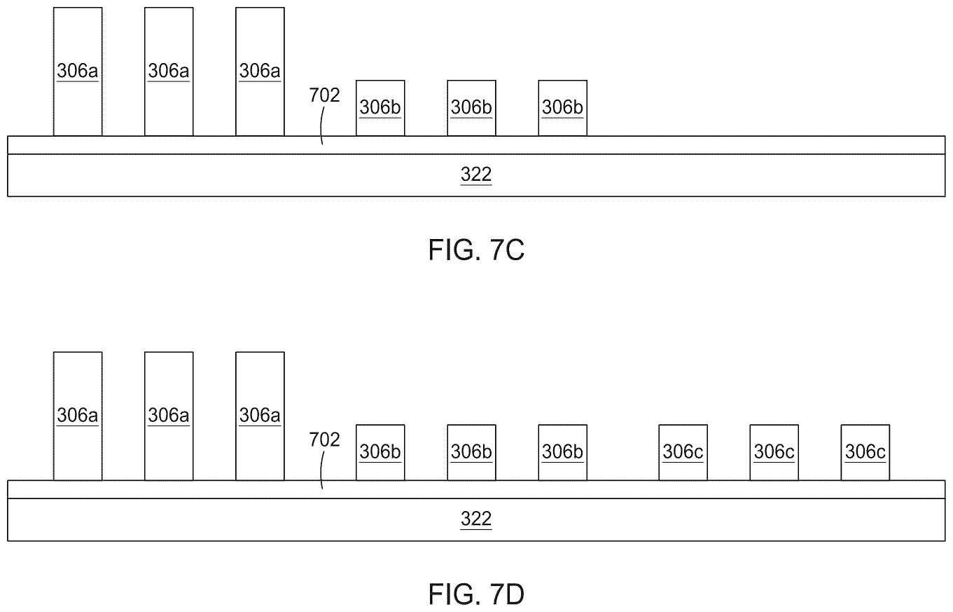

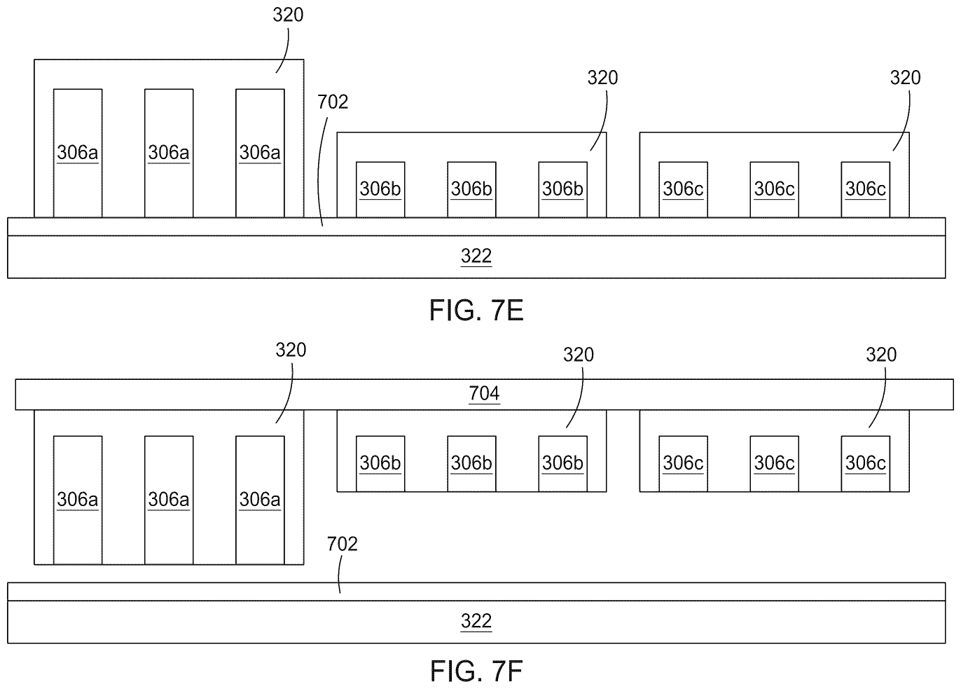

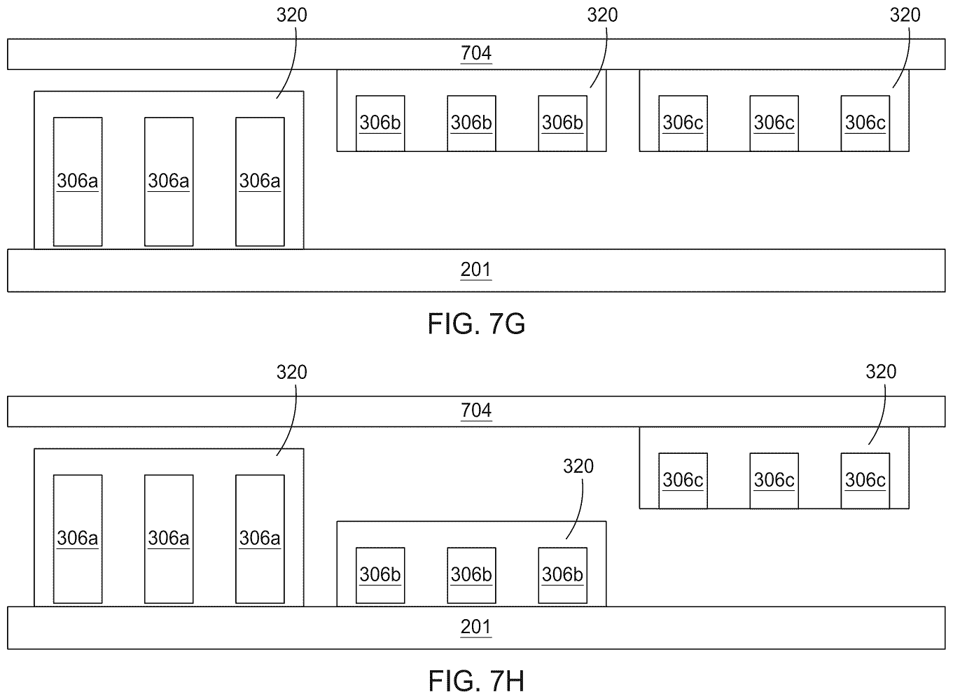

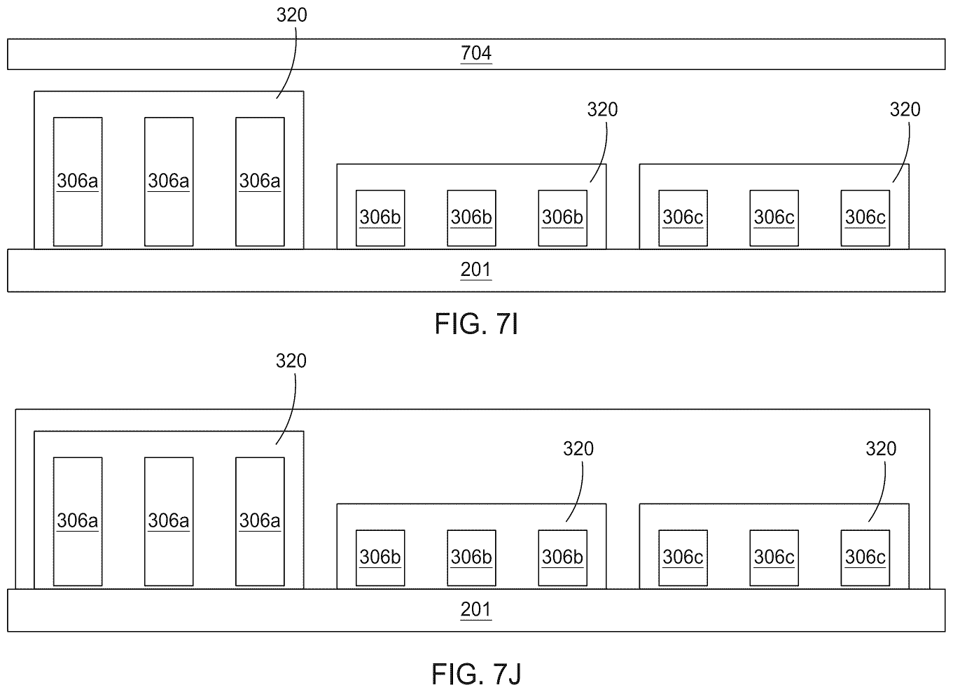

At operation 104, as shown in FIG. 2, the first grating 204a, is transferred to a waveguide substrate 201. In some embodiments, the first grating 204a may be transferred from the first donor substrate 208 to the waveguide substrate 201 using a transfer substrate, as described herein in referenced to FIGS. 7A-7J. In some embodiments, the first grating 204a may be transferred to the waveguide substrate 201 by dicing the first grating 204a from the donor substrate and inverting the first grating 204a onto a top surface of the waveguide substrate 201. Optionally, an adhesive layer may be placed between the first grating 204a and the substrate 201, thereby improving adhesion between the first grating 204a and the waveguide substrate 201. In some embodiments, the waveguide substrate 201 can be surface treated, e.g., chemically treated via a chemical treatment process or plasma treated via a plasma treatment process, to enhance adhesion between the first grating 204a and the substrate 201.

Optionally, as shown in FIG. 2, a second grating 204b is disposed over a second donor substrate 212. The second grating 204b can be different than the first grating 204a. The second grating 204b can be the same as the first grating 204a. In some embodiments, which can be combined with other embodiments, the first donor substrate 208 and the second donor substrate 212 are the same or different. In some embodiments, the second donor substrate 212 is the waveguide substrate 201. In some embodiments, which can be combined with other embodiments, a plurality of second gratings 204b can be disposed over the second donor substrate 212 and/or the waveguide substrate 201. Each second grating 204b of the plurality of second gratings include a second device structure, as described herein in referenced to FIGS. 3A-3C. The second grating 204b is disposed by depositing device material over the second donor substrate 212 and/or the waveguide substrate 201. The device material is then patterned to form the second grating 204b. The second grating 204b can be deposited via one or more deposition processes, e.g., chemical vapor deposition, physical vapor desorption, plasma enhanced deposition, or a combination thereof. The patterning process to form the second grating 204b includes, but is not limited to, nano-imprint lithography, reactive ion etching, ion beam etching, or combinations thereof.

Optionally, as shown in FIG. 2, a plurality of third gratings 204c are disposed over a third donor substrate 216 and/or the waveguide substrate 201. The third grating 204c can be different than the first grating 204a and/or the second grating 205b. The third grating 204c can be the same as the first grating 204a and/or the second grating 204b. In some embodiments, which can be combined with other embodiments, the first donor substrate 208, the second donor substrate 212, and the third donor substrate 216 are the same or different. Each third grating 204c of the plurality of third gratings 204c includes a third device structure 206c. The third grating 204c is disposed by depositing device material over the third donor substrate 216. The device material is then patterned to form the third grating 204c. The third grating 204c can be deposited via one or more deposition processes, e.g., chemical vapor deposition, physical vapor desorption, plasma enhanced deposition, or a combination thereof. The patterning process to form the third grating 204c includes, but is not limited to, nano-imprint lithography, reactive ion etching, ion beam etching, or combinations thereof.

Optionally, as shown in FIG. 2, the second grating 204b is transferred to the waveguide substrate 201, e.g., when the second grating 204b is not the waveguide substrate 201. In some embodiments, the second grating 204b may be transferred from the second donor substrate 212 to the waveguide substrate 201 using a transfer substrate, as described herein in referenced to FIGS. 7A-7J. In some embodiments, the second grating 204b may be transferred to the waveguide substrate 201 by dicing the second grating 204b from the second donor substrate 212 and inverting the second grating 204b onto a top surface of the waveguide substrate 201. Optionally, an adhesive layer may be placed between the second grating 204b and the substrate 201, thereby improving adhesion between the second grating 204b and the waveguide substrate 201.

Optionally, as shown in FIG. 2, the third grating 204c, is transferred to the waveguide substrate 201. In some embodiments, the third grating 204c may be transferred from the third donor substrate 216 to the waveguide substrate 201 using a transfer substrate, as described herein in referenced to FIGS. 7A-7J. In some embodiments, the third grating 204c may be transferred to the waveguide substrate 201 by dicing the third grating 204c from the third donor substrate 216 and inverting the third grating 204c onto a top surface of the waveguide substrate 201. Optionally, an adhesive layer may be placed between the third grating 204c and the substrate 201, thereby improving adhesion between the third grating 204c and the waveguide substrate 201.

Optionally, an encapsulation layer is disposed over the first grating 204a, the second grating 204b, the third grating 204c, and/or the substrate 201. The encapsulation layer may be formed using one or more vapor deposition processes which utilize plasma such as PVD or sputtering processes, a furnace CVD (FCVD) process, a PE-CVD process, a PE-ALD process, or other plasma processes. Optionally, one or more additional processes, e.g., polishing, dicing, edge blackening, or a combination thereof, may be performed following encapsulation.

FIG. 3A illustrates a perspective, frontal view of a waveguide combiner 300. It is to be understood that the waveguide combiner 300 described herein is an exemplary waveguide combiner. The waveguide combiner 300 is an augmented reality waveguide combiner. The waveguide combiner 300 includes a plurality of device structures 302 disposed on a substrate 201, e.g., a waveguide substrate. While FIG. 3A shows the plurality of device structures only disposed over a top surface of the waveguide combiner 300, the plurality of device structures may be independently disposed on a top side or a bottom side of the waveguide combiner 300. The substrate 201 may be of varying shapes, thicknesses, and diameters. For example, the substrate 201 may have a diameter of about 50 mm to about 500 mm. The substrate 201 may have a circular, rectangular, or square shape. The substrate 201 may have a thickness of between about 300 μm to about 1 mm.

The substrate 201 can be any substrate used in the art, and can be either opaque or transparent to a chosen wavelength of light, depending for the use of the substrate 201 as a substrate for a waveguide. Substrate selection may include substrates of any suitable material, including, but not limited to, amorphous dielectrics, non-amorphous dielectrics, crystalline dielectrics, polymers, or combinations thereof. In some embodiments, the substrate 201 includes, but is not limited to, a silicon-containing material, a silicon and oxygen containing compound, a germanium-containing material, an indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, an indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. In other embodiments, which can be combined with other embodiments described herein, the substrate 201 includes an oxide including one or more of gadolinium, silicon, sodium, barium, potassium, tungsten, phosphorus, zinc, calcium, titanium, tantalum, niobium, lanthanum, zirconium, lithium, or yttrium containing-materials. Example materials of the substrate 201 include silicon (Si), silicon monoxide (SiO), silicon dioxide (SiO₂), silicon carbide (SiC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd₂O₅), zinc oxide (ZnO), yttrium oxide (Y₂O₃), tungsten oxide (WO3), titatium oxide (TiO₂), zirconium oxide (ZrO₃), sodium oxide (Na₂O), niobium oxide (Nb₂O₅), barium oxide (BaO), potassium oxide (K₂O), phosphorus pentoxide (P₂O₅), calcium oxide (CaO), or combinations thereof.

The device structures 302 can be nanostructures having sub-micron dimensions, e.g., nano-sized dimensions, such as critical dimensions less than 1 μm. Regions of the device structures 302 can correspond to one or more gratings 204, such as a first grating 204a, a second grating 204b, and a third grating 204c. The waveguide combiner 300 includes at least the first grating 304a corresponding to an input coupling grating and the third grating 304c corresponding to an output coupling grating. The waveguide combiner 200 can include the second grating 304b corresponding to an intermediate grating.

The first grating 204a has first device structures 306a. Although only nine first device structures 306a are shown on the substrate 201, any number of first device structures 306a may be disposed on the substrate 201. The second grating 204b has second device structures 306b. Although only twenty-six second device structures are shown on the substrate 201, any number of second device structures 306b may be disposed on the substrate 201. The third grating 204c has third device structures 306c. Although only fourteen third device structures are shown on the substrate 201, any number of third device structures 306c may be disposed on the substrate 201.

The device structures 302 and the substrate 201 can include a different material. The substrate 201 includes, but is not limited to, one or more oxides, carbides, or nitrides of silicon, aluminum, zirconium, tin, tantalum, zirconium, barium, titanium, hafnium, lithium, lanthanum, cadmium, niobium, or combinations thereof. Example materials of the device structures 302 include silicon carbide, silicon oxycarbide, titanium oxide, silicon oxide, vanadium oxide, aluminum oxide, aluminum-doped zinc oxide, indium tin oxide, tin oxide, zinc oxide, tantalum oxide, silicon nitride, zirconium oxide, niobium oxide, cadmium stannate, silicon oxynitride, barium titanate, diamond like carbon, hafnium oxide, lithium niobate, silicon carbon-nitride, silver, cadmium selenide, mercury telluride, zinc selenide, silver-indium-gallium-sulfur, silver-indium-sulfur, indium phosphide, gallium phosphide, lead sulfide, lead selenide, zinc sulfide, molybdenum sulfide, tungsten sulfide, or combinations thereof.

FIG. 3B is a schematic, cross-sectional view of the waveguide combiner 300. The first device structures 306a, the second device structures 306b, and the third device structures 306c can independently include substantially vertical device structures, binary device structures, blazed device structures, staircase device structures, or a combination thereof. A coating layer 320 is disposed over the device structures 302, e.g., the first device structures 306a, the second device structures 306b, and the third device structures 306c. The coating layer 320 can include one or more of a silicon-based material, a silicon nitride-based material, an aluminum-based material, or a combination thereof. In some embodiments, the coating layer 320 can be disposed between the device structures 302, e.g., the first device structures 306a, the second device structures 306b, and the third device structures 306c, and the substrate 201. A coating layer 320 that is disposed between the device structures 302 and the substrate 201 can couple and/or bond the device structures 302 to the substrate 201.

In embodiments, the coating layer 320 may include separate layers, or the coating layer 320 may be a single layer (not shown) that wraps around the substrate 201 to coat the top and bottom of the substrate 201.

Alternatively, as shown in FIG. 3C, an adhesive layer 324 is disposed between the device structures 302, e.g., the first device structures 306a, the second device structures 306b, and the third device structures 306c, and the substrate 201. The adhesive layer 324 can include a material having a refractive index of about 1.0 to about 1.8. In some embodiments, which can be combined with other embodiments, the adhesive layer 324 can include an aerogel material, an epoxy material, or a substantially transparent material suitable to bond the device structures 302 to the substrate 201. The adhesive layer 324 disposed between the device structures 302 and the substrate 201 can couple and/or bond the device structures 302 to the substrate 201.

Optionally, a donor substrate 322 is disposed over the coating layer 320. The donor substrate 322 may include substrates of any suitable material, including, but not limited to, amorphous dielectrics, non-amorphous dielectrics, crystalline dielectrics, polymers, or combinations thereof. In some embodiments, the donor substrate 322 includes, but is not limited to, a silicon-containing material, a silicon and oxygen containing compound, a germanium-containing material, an indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, an indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. For example, the donor substrate 322 can include silicon.

An encapsulation layer 326 is disposed over the first device structures 306a of the first grating 204a, the second device structures 306b of the second grating 204b, and the third device structures 306c of the third grating 204c. The encapsulation layer 326 includes, but is not limited to, aluminum, silver, gold, chromium, silicon nitride, silicon oxide, or combinations thereof. Example of the encapsulation layer 326 includes silicon dioxide, aluminum oxide, magnesium oxide, or combinations thereof. The encapsulation layer 326 may be formed using one or more vapor deposition processes which utilize plasma such as PVD or sputtering processes, a furnace CVD (FCVD) process, a PE-CVD process, a PE-ALD process, or other plasma processes.

In one or more examples, the encapsulation layer 326 may be deposited by a PVD process which includes generating ozone or an oxygen plasma while depositing the encapsulation layer 326. For example, silver may be deposited in a magnetron sputtering PVD chamber using a silicon target and depositing reactively with a plasma containing argon and oxygen (Ar/O₂). The encapsulation layer 326 may have a thickness of about 10 nm to about 200 nm, or greater.

Optionally, the substrate 201 can include a curved substrate. The curved substrate can include a substrate having one or more bends, curves, or a combination thereof. The methods described herein can allow for curved substrates to be utilized due to the individualized fabrication of the waveguide, e.g., disposing an incoupler grating, pupil expander grating, or an outcoupler grating individually on the curved substrate.

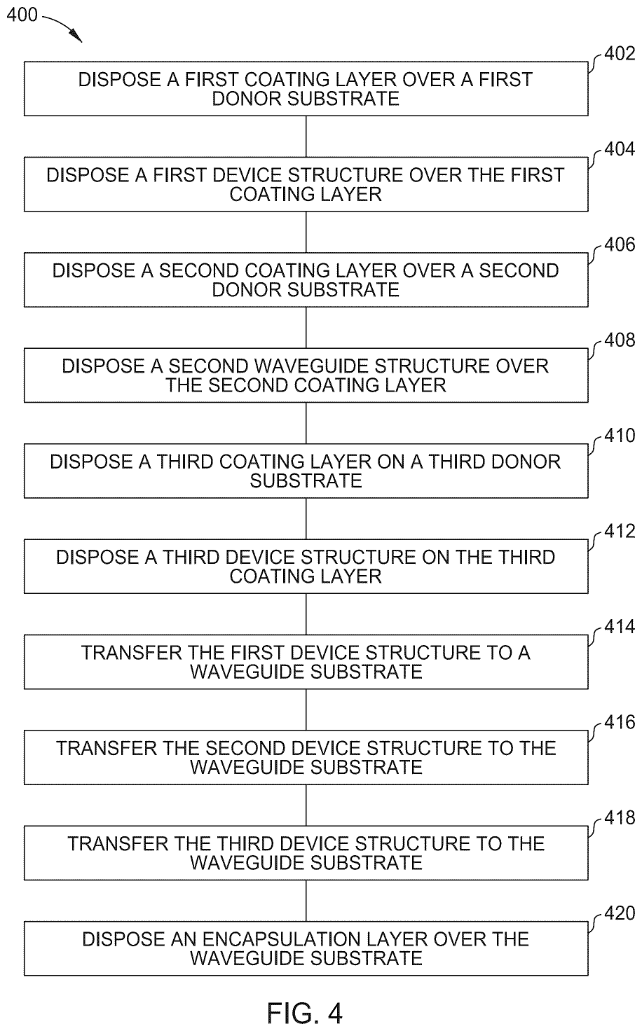

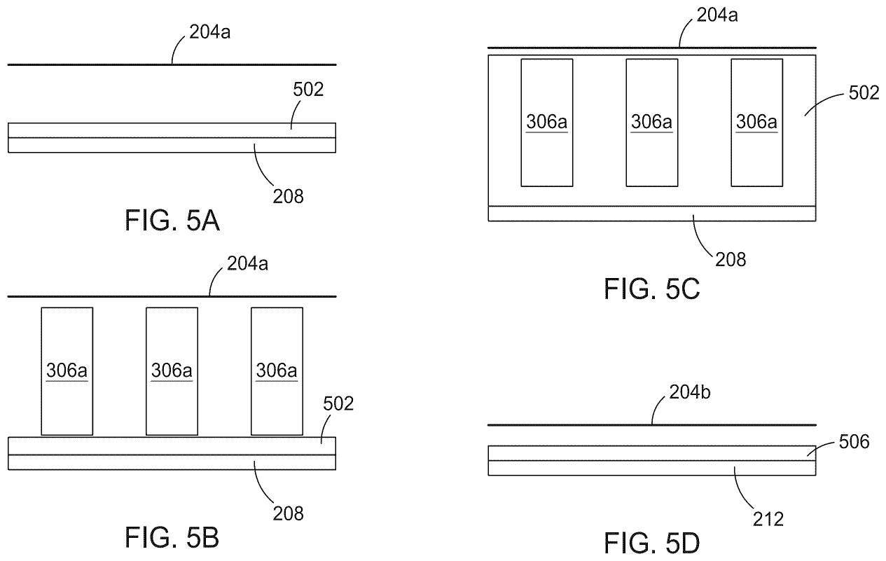

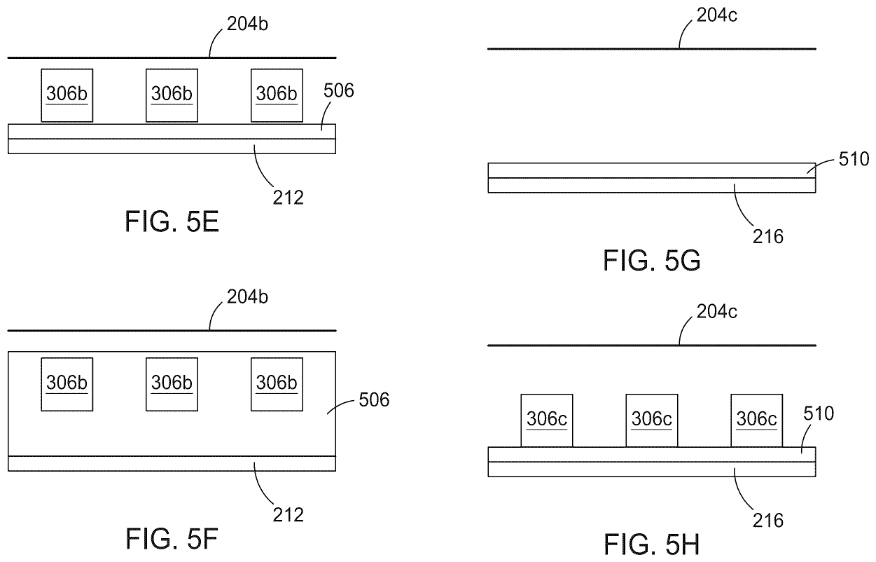

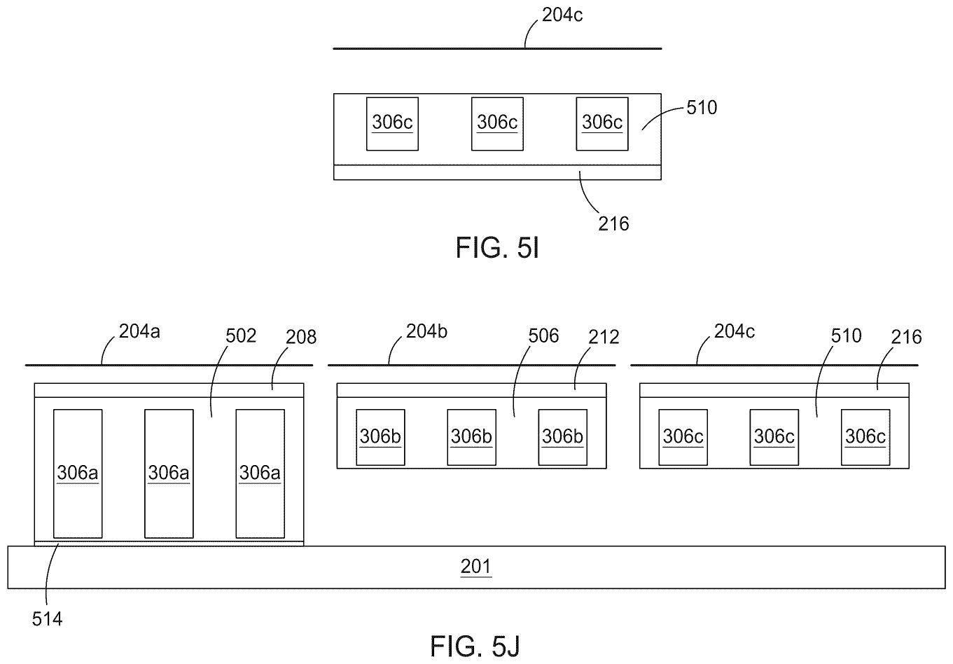

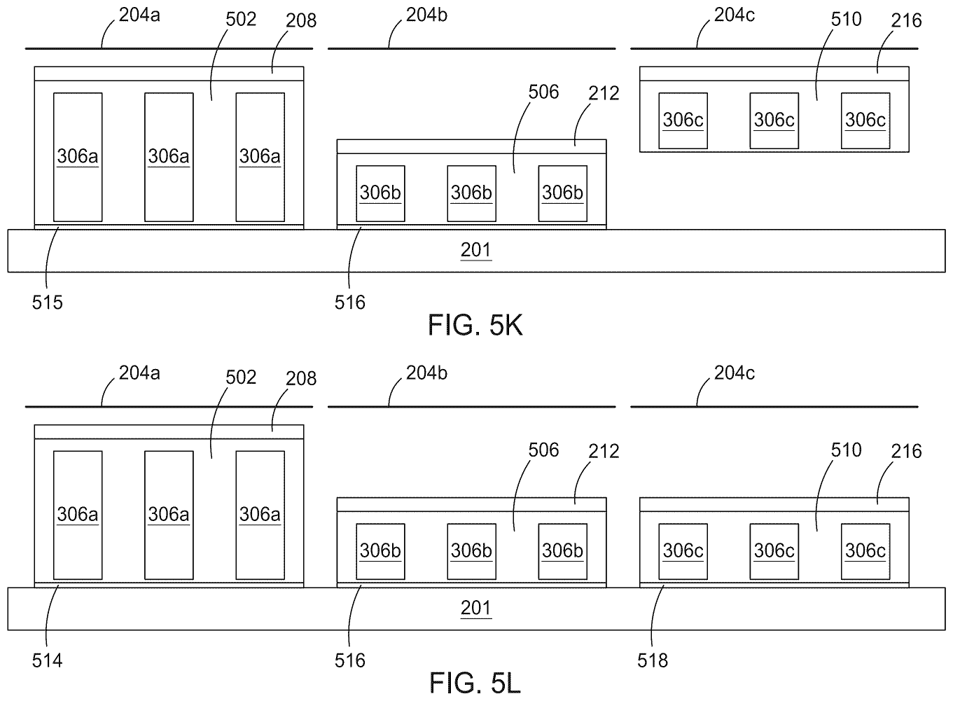

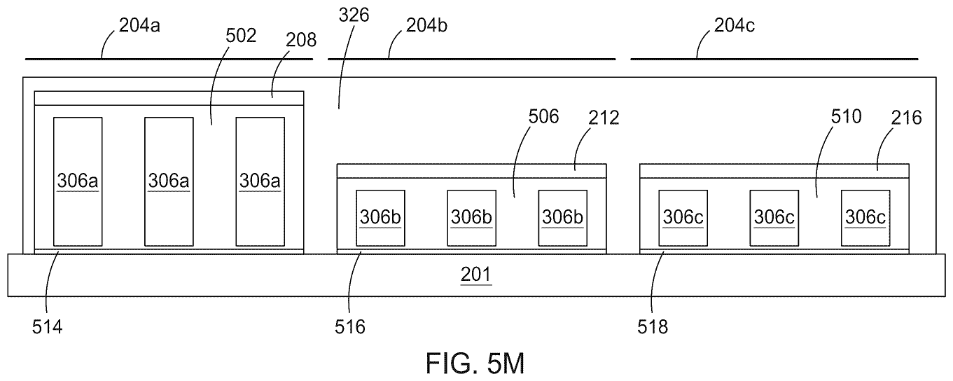

FIG. 4 is a flow diagram of a method 400 for forming a waveguide combiner 300. FIGS. 5A-5M show portions of device structures 302. In one embodiment, the device structures 302 include at least one of silicon oxycarbide (SiOC), titanium dioxide (TiO₂), silicon dioxide (SiO₂), vanadium (IV) oxide (VOₓ), aluminum oxide (Al₂O₃), indium tin oxide (ITO), zinc oxide (ZnO), tantalum pentoxide (Ta₂O₅), silicon nitride (Si₃N₄), titanium nitride (TiN), and zirconium dioxide (ZrO₂) containing materials.

At operation 402, as shown in FIG. 5A, a first coating layer 502 is disposed over a first donor substrate 208. The first coating layer 502 can include the coating layer 320 as described herein. For example, the first coating layer 502 can include one or more of a silicon-based material, a silicon nitride-based material, an aluminum-based material, or a combination thereof. The first donor substrate 208 can include the donor substrate 322 as described herein. For example, the first donor substrate 208 can include a silicon-containing material, a silicon and oxygen containing compound, a germanium-containing material, an indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, an indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. The first coating layer 502 can be disposed on the first donor substrate 208 using one or more deposition processes, e.g., chemical vapor deposition, physical vapor desorption, plasma enhanced deposition, or a combination thereof.

At operation 404, as shown in FIG. 5B, the first device structures 306a are disposed over the first coating layer 502. The first device structures 306a are disposed by depositing device material over portions of the first donor substrate 504. The device material is then patterned to form the first device structures 306a. The device material can be deposited via one or more deposition processes, e.g., chemical vapor deposition, physical vapor desorption, plasma enhanced deposition, or a combination thereof. Optionally, as shown in FIG. 5C, the first coating layer 502 is deposited again, such that the first coating layer 502 is disposed between the first device structures 306a. The patterning process to form the first device structures 306a includes, but is not limited to, nano-imprint lithography, reactive ion etching, ion beam etching, or combinations thereof. In some embodiments, which can be combine with other embodiments, the first coating layer 502 can be disposed over a top surface of the first device structures 306a. A first coating layer 502 disposed over the top surface of the first device structures 306a may enhanced adhesion between the substrate 201 and the first device structures 306a.

At operation 406, as shown in FIG. 5D, a second coating layer 506 is disposed over a second donor substrate 212. The second coating layer 506 can include the coating layer 320 as described herein. For example, the second coating layer 506 can include one or more of a silicon-based material, a silicon nitride-based material, an aluminum-based material, or a combination thereof. The second donor substrate 508 can include the donor substrate 322 as described herein. For example, the second donor substrate 212 can include a silicon-containing material, a silicon and oxygen containing compound, a germanium-containing material, an indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, an indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. The second coating layer 506 can be disposed on the second donor substrate 212 using one or more deposition processes, e.g., chemical vapor deposition, physical vapor desorption, plasma enhanced deposition, or a combination thereof.

At operation 408, as shown in FIG. 5E, the second device structures 306b are disposed over the second coating layer 506. The second device structures 306b are disposed by depositing device material over portions of the second donor substrate 212. The device material is then patterned to form the second device structures 306b. The device material can be deposited via one or more deposition processes, e.g., chemical vapor deposition, physical vapor desorption, plasma enhanced deposition, or a combination thereof. Optionally, as shown in FIG. 5F, the second coating layer 506 is deposited again, such that the second coating layer 506 is disposed between the second device structures 306b. The patterning process to form the second device structures 306b includes, but is not limited to, nano-imprint lithography, reactive ion etching, ion beam etching, or combinations thereof. In some embodiments, which can be combined with other embodiments, the second coating layer 506 can be disposed over a top surface of the second device structures 306b. A second coating layer 506 disposed over the top surface of the second device structures 306b may enhanced adhesion between the substrate 201 and the second device structures 306b.

At operation 410, as shown in FIG. 5G, a third coating layer 510 is disposed over a third donor substrate 216. The third coating layer 510 can include the coating layer 320 as described herein. For example, the third coating layer 510 can include one or more of a silicon-based material, a silicon nitride-based material, an aluminum-based material, or a combination thereof. The third donor substrate 512 can include the donor substrate 322 as described herein. For example, the third donor substrate 512 can include a silicon-containing material, a silicon and oxygen containing compound, a germanium-containing material, an indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, an indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. The third coating layer 510 can be disposed on the third donor substrate 216 using one or more deposition processes, e.g., chemical vapor deposition, physical vapor desorption, plasma enhanced deposition, or a combination thereof.

At operation 412, as shown in FIG. 5H, the third device structures 306c are disposed over the third coating layer 510. The third device structures 306c are disposed by depositing device material over portions of the third donor substrate 216. The device material is then patterned to form the third device structures 306c. The device material can be deposited via one or more deposition processes, e.g., chemical vapor deposition, physical vapor desorption, plasma enhanced deposition, or a combination thereof. Optionally, as shown in FIG. 5I, the third coating layer 510 is deposited again, such that the third coating layer 510 is disposed between the third device structures 306c. The patterning process to form the third device structures 306c includes, but is not limited to, nano-imprint lithography, reactive ion etching, ion beam etching, or combinations thereof. In some embodiments, which can be combined with other embodiments, the third coating layer 510 can be disposed over a top surface of the third device structures 306c. A third coating layer 510 disposed over the top surface of the third device structures 306c may enhanced adhesion between the substrate 201 and the third device structures 306c.

At operation 414, as shown in FIG. 5J, the first device structure 306a is disposed over the substrate 201. In some embodiments, the first donor substrate 208 is inverted and the first device structures 306a are disposed over a top surface of the substrate 201. Optionally, a first adhesive layer 514 is disposed between the first coating layer 502 and the substrate 201. The first adhesive layer 514 can include any of the adhesive layer 324, as described herein. For example, the first adhesive layer 514 can include a material having a refractive index of about 1.0 to about 1.8. As a further example, the first adhesive layer 514 can include an aerogel material, an epoxy material, or a substantially transparent material suitable to bond the first device structures 306a and/or the first coating layer 502 to the substrate 201. The first adhesive layer 514 is disposed between the first coating layer 502 or the first device structures 306a and the substrate 201 such that the first adhesive layer 514 can couple and/or bond the first device structures 306a or the first coating layer 502 to the substrate 201.

At operation 416, as shown in FIG. 5K, the second device structure 306b is disposed over the substrate 201. In some embodiments, the second donor substrate 508 is inverted and the second device structures 306b are disposed over a top surface of the substrate 201. Optionally, a second adhesive layer 516 is disposed between the second coating layer 506 and the substrate 201. The second adhesive layer 516 can include any of the adhesive layer 324, as described herein. For example, the second adhesive layer 516 can include a material having a refractive index of about 1.0 to about 1.8. As a further example, the second adhesive layer 516 can include an aerogel material, an epoxy material, or a substantially transparent material suitable to bond the second device structures 306b and/or the second coating layer 506 to the substrate 201. The second adhesive layer 516 is disposed between the second coating layer 506 or the second device structures 306b and the substrate 201 such that the second adhesive layer 516 can couple and/or bond the second device structures 306b or the second coating layer 506 to the substrate 201.

At operation 418, as shown in FIG. 5L, the third device structure 306c is disposed over the substrate 201. In some embodiments, the third donor substrate 216 is inverted and the third device structure 306c are disposed over a top surface of the substrate 201. Optionally, a third adhesive layer 518 is disposed between the third coating layer 510 and the substrate 201. The third adhesive layer 518 can include any of the adhesive layer 324, as described herein. For example, the third adhesive layer 518 can include a material having a refractive index of about 1.0 to about 1.8. As a further example, the third adhesive layer 518 can include an aerogel material, an epoxy material, or a substantially transparent material suitable to bond the third device structures 306c and/or the third coating layer 510 to the substrate 201. The third adhesive layer 518 is disposed between the third coating layer 510 or the third device structures 306c and the substrate 201 such that the third adhesive layer 518 can couple and/or bond the second device structures 306b or the second coating layer 506 to the substrate 201.

At operation 420, as shown in FIG. 5M, an encapsulation layer 326 is disposed over the first donor substrate 208, the second donor substrate 212, and the third donor substrate 216. The encapsulation layer 326 may be formed using one or more vapor deposition processes which utilize plasma such as PVD or sputtering processes, a furnace CVD (FCVD) process, a PE-CVD process, a PE-ALD process, or other plasma processes. Optionally, one or more additional processes, e.g., polishing, dicing, edge blackening, or a combination thereof, may be performed following encapsulation.

The waveguide combiner 300 of the present disclosure may be repaired or reworked by removing the first device structure 306a, the second device structure 306b, and/or the third device structure 306c and remounting the same structure or mounting a replacement structure of the same type as the removed structure. Similarly, a curved waveguide combiner may be repaired or reworked by removing the first device structure 306a, the second device structure 306b, and/or the third device structure 306c and remounting the same structure or mounting a replacement structure of the same type as the removed structure.

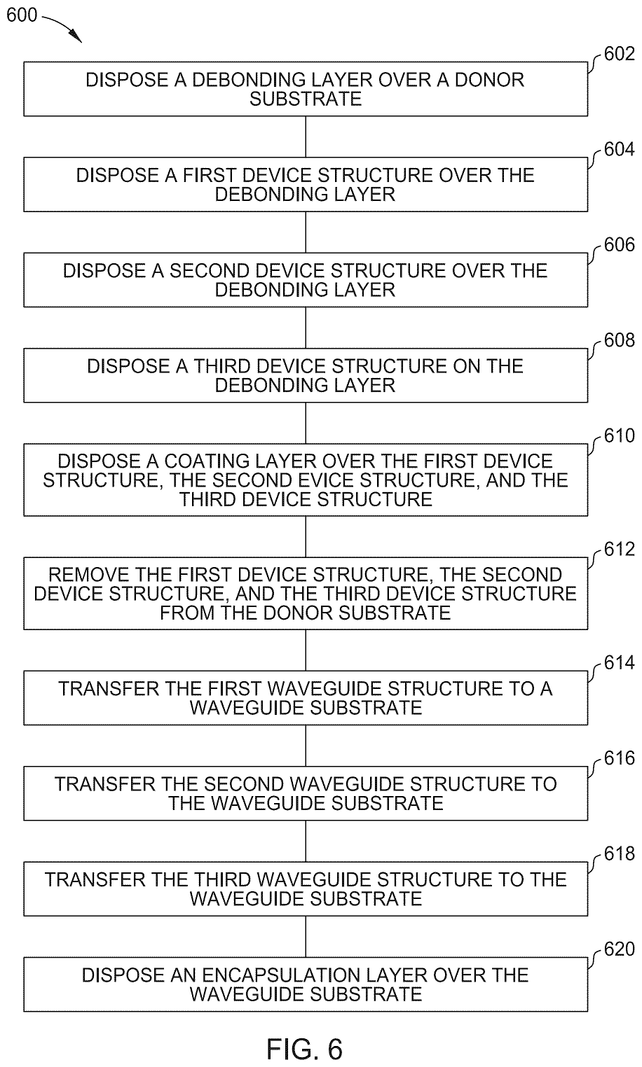

FIG. 6 is a flow diagram of a method 600 for forming a waveguide combiner 300. FIGS. 7A-7J show portions of device structures 302. In one embodiment, the device structures 302 include at least one of silicon oxycarbide (SiOC), titanium dioxide (TiO₂), silicon dioxide (SiO₂), vanadium (IV) oxide (VOₓ), aluminum oxide (Al₂O₃), indium tin oxide (ITO), zinc oxide (ZnO), tantalum pentoxide (Ta₂O₅), silicon nitride (Si₃N₄), titanium nitride (TiN), and zirconium dioxide (ZrO₂) containing materials.

At operation 602, as shown in FIG. 7A, a debonding layer 702 is disposed over a donor substrate 322. The debonding layer 702 can include one or more of a silicon-based material, a silicon nitride-based material, an aluminum-based material, or a combination thereof. The debonding layer 702 can be configured to remove and/or dissociate a device structure from the debonding layer, such that the debonding layer remains attached to the donor substrate 322, and the device structures de-bond or remove from the debonding layer 702. The debonding layer 702 can be disposed on the donor substrate 322 using one or more deposition processes, e.g., chemical vapor deposition, physical vapor desorption, plasma enhanced deposition, or a combination thereof.

At operation 604, as shown in FIG. 7B, the first device structures 306a are disposed over the debonding layer 702. The first device structures 306a are disposed by depositing device material over the debonding layer 702. The device material is then patterned to form the first device structures 306a. The device material can be deposited via one or more deposition processes, e.g., chemical vapor deposition, physical vapor desorption, plasma enhanced deposition, or a combination thereof. The patterning process to form the first device structures 306a includes, but is not limited to, nano-imprint lithography, reactive ion etching, ion beam etching, or combinations thereof.

At operation 606, as shown in FIG. 7C, the second device structures 306b are disposed over the debonding layer 702. The second device structures 306b are disposed by depositing device material over the debonding layer 702. The device material is then patterned to form the first device structures 306a. The device material can be deposited via one or more deposition processes, e.g., chemical vapor deposition, physical vapor desorption, plasma enhanced deposition, or a combination thereof. The patterning process to form the second device structures 306b includes, but is not limited to, nano-imprint lithography, reactive ion etching, ion beam etching, or combinations thereof.

At operation 608, as shown in FIG. 7D, the third device structures 306c are disposed over the debonding layer 702. The third device structures 306c are disposed by depositing device material over the debonding layer 702. The device material is then patterned to form the third device structures 306c. The device material can be deposited via one or more deposition processes, e.g., chemical vapor deposition, physical vapor desorption, plasma enhanced deposition, or a combination thereof. The patterning process to form the first device structures 306a includes, but is not limited to, nano-imprint lithography, reactive ion etching, ion beam etching, or combinations thereof.

At operation 610, as shown in FIG. 7E, a coating layer 320 is disposed over the first device structures 306a, the second device structures 306b, and the third device structures 306c. The coating layer 320 can include one or more of a silicon-based material, a silicon nitride-based material, an aluminum-based material, or a combination thereof. The coating layer 320 can be disposed over the first device structures 306a, the second device structures 306b, and the third device structures 306c using one or more deposition processes, e.g., chemical vapor deposition, physical vapor desorption, plasma enhanced deposition, or a combination thereof.

At operation 612, as shown in FIG. 7F, the first device structures 306a, the second device structures 306b, and the third device structures 306c are removed from the donor substrate 322 using a transfer substrate 704. The transfer substrate 704 includes a substrate capable of bonding to and/or adhering to the coating layer 320. For example, the transfer substrate 704 can include a polymer and/or inorganic material having an adhesive layer. In some embodiments, the transfer substrate 704 can include a tape material. The transfer substrate 704 can contact the coating layer 320 and remove the first device structure 306a, the second device structure 306b, and/or the third device structure 306c from the debonding layer 702. The debonding layer 702 may remain adhered to and/or in contact with the donor substrate 322.

At operation 614, as shown in FIG. 7G, the first device structure 306a is disposed over the substrate 201. In some embodiments, the transfer substrate 704 is disposed over the substrate 201, in which the first device structure 306a is disposed on the substrate 201 and bonded to the substrate 201. In some embodiments, the first device structures 306a are disposed over a top surface of the substrate 201. In some embodiments, an adhesive layer is disposed between the first device structure 306a and the substrate 201. The adhesive layer can include any of the adhesive layer 324, as described herein. In some embodiments, the substrate 201 can be surface treated, e.g., chemically treated via a chemical treatment process or plasma treated via a plasma treatment process, to enhance adhesion between the first device structure 306a and the substrate 201.

At operation 616, as shown in FIG. 7H, the second device structure 306b is disposed over the substrate 201. In some embodiments, the transfer substrate 704 is disposed over the substrate 201, in which the second device structure 306b is disposed on the substrate 201 and bonded to the substrate 201. In some embodiments, the second device structures 306b are disposed over a top surface of the substrate 201. In some embodiments, an adhesive layer is disposed between the second device structure 306b and the substrate 201. The adhesive layer can include any of the adhesive layer 324, as described herein. In some embodiments, the substrate 201 can be surface treated, e.g., chemically treated or plasma treated, to enhance adhesion between the second device structure 306b and the substrate 201.

At operation 618, as shown in FIG. 7I, the third device structure 306c is disposed over the substrate 201. In some embodiments, the transfer substrate 704 is disposed over the substrate 301, in which the third device structure 306c is disposed on the substrate 201 and bonded to the substrate 201. In some embodiments, the third device structure 306c is disposed over a top surface of the substrate 201. In some embodiments, an adhesive layer is disposed between the second device structure 306b and the substrate 201. The adhesive layer can include any of the adhesive layer 324, as described herein. In some embodiments, the substrate 201 can be surface treated, e.g., chemically treated or plasma treated, to enhance adhesion between the third device structure 306c and the substrate 201.

At operation 620, as shown in FIG. 7J, an encapsulation layer 326 is disposed over the coating layer 320 and substrate 201. The encapsulation layer 326 may be formed using one or more vapor deposition processes which utilize plasma such as PVD or sputtering processes, a furnace CVD (FCVD) process, a PE-CVD process, a PE-ALD process, or other plasma processes. Optionally, one or more additional processes, e.g., polishing, dicing, edge blackening, or a combination thereof, may be performed following encapsulation.

The waveguide combiner 300 of the present disclosure may be repaired or reworked by removing the first device structure 306a, the second device structure 306b, and/or the third device structure 306c and remounting the same structure or mounting a replacement structure of the same type as the removed structure. Similarly, a curved waveguide combiner may be repaired or reworked by removing the first device structure 306a, the second device structure 306b, and/or the third device structure 306c and remounting the same structure or mounting a replacement structure of the same type as the removed structure.

In operation, the waveguide combiner 300 may be optically coupled to a light emitter (LE) and a metrology/calibration instrument. In some embodiments, the light emitter may be a microdisplay. The light emitter may project an image into the first grating 204a, e.g., the incoupler gratings, of the waveguide combiner 300, and the metrology/calibration instrument may receive light from the third grating 204c, e.g., the outcoupler gratings, of the waveguide combiner 300. Measurements from the metrology/calibration instrument may be used in calibrating the light emitter to enable the image emitted from the third grating 204c, e.g., the outcoupler gratings, to be clear. In some embodiments, the light emitter may project into the first grating 204a, e.g., the incoupler gratings, from a concave side of the waveguide combiner 300 in embodiments of the present disclosure. Alternatively, the third grating 204c, e.g., the outcoupler gratings, of the waveguide combiner 200 may project the image from the concave side in embodiments of the present disclosure.

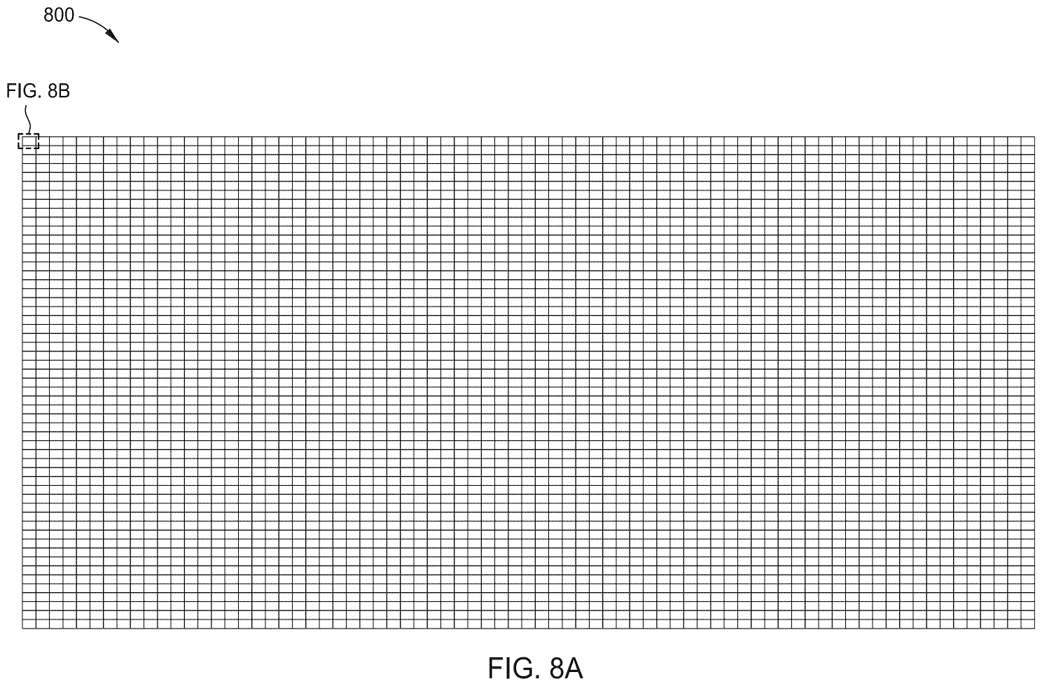

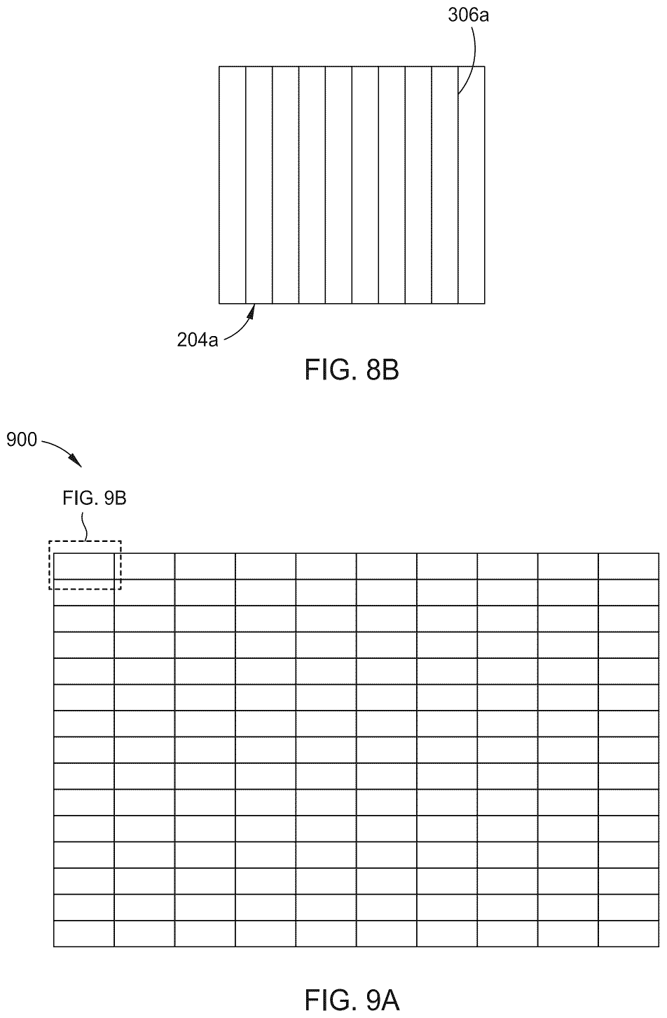

FIG. 8A is a schematic view of an arrangement 800 of first gratings 204a, e.g., incoupler gratings, on the donor substrate 322, according to embodiments of the present disclosure. In some embodiments, about 1 to about 4000 first gratings 204a, e.g., incoupler gratings, may be formed on the donor substrate 322. In other embodiments of the present disclosure, about 1 to about 500 first gratings 204a may be formed on the donor substrate 322. Each first grating 204a may include one or more device structures, e.g., first device structures 306a, suitable for inclusion in a waveguide combiner, such as the waveguide combiner 300, shown in FIG. 3A. For example, each first grating 204a may include about nine first device structures 306a suitable for including in a waveguide combiner, as shown in FIG. 8B. In some embodiments, each first grating 204a may have a diameter of approximately 3 mm. In some embodiments, a first grating 204a may be diced off of the donor substrate 322 and used in manufacturing a waveguide combiner, as described herein.

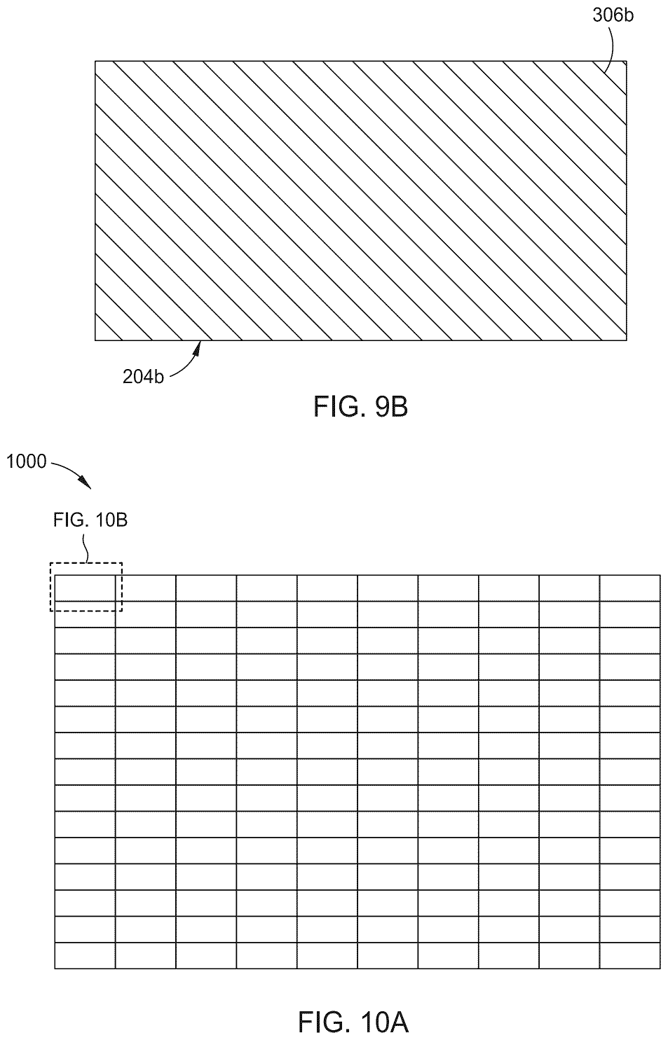

FIG. 9B is a schematic view of an arrangement 900 of second gratings 204b, e.g., pupil expander gratings, on the donor substrate 322, according to embodiments of the present disclosure. In some embodiments, about 1 to about 150 second gratings 204b, e.g., pupil expander gratings, may be formed on the donor substrate 322. In other embodiments of the present disclosure, about 1 to about 100 second gratings 204b may be formed on the donor substrate 322. Each second grating 204b may include one or more device structures, e.g., second device structures 306b, suitable for inclusion in a waveguide combiner, such as the waveguide combiner 300, shown in FIG. 3A. For example, each second grating 204b may include about twenty-six second device structures suitable for including in a waveguide combiner, as shown in FIG. 9B. In some embodiments, a second grating 204b may be diced off of the donor substrate 322 and used in manufacturing a waveguide combiner, as described herein.

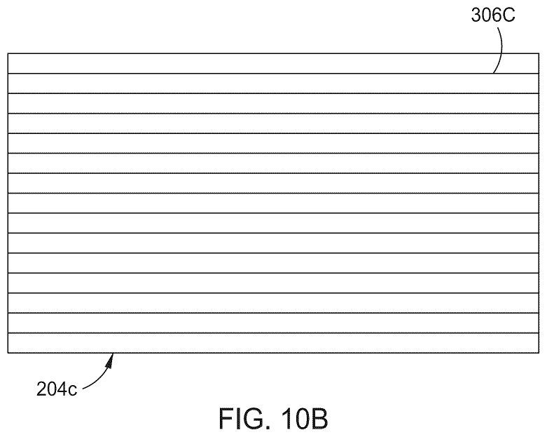

FIG. 10A is a schematic view of an arrangement 1000 of third gratings 204c, e.g., outcoupler gratings, on the donor substrate 322, according to embodiments of the present disclosure. In some embodiments, about 1 to about 150 third gratings 204c, e.g., outcoupler gratings, may be formed on the donor substrate 322. In other embodiments of the present disclosure, about 1 to about 100 third gratings 204c may be formed on the donor substrate 322. Each third grating 204c may include one or more device structures, e.g., third device structures 306c, suitable for inclusion in a waveguide combiner, such as the waveguide combiner 300, shown in FIG. 3A. For example, each third grating 204c may include about fourteen third device structures suitable for including in a waveguide combiner, as shown in FIG. 10B. In some embodiments, a third gratings 204C may be diced off of the donor substrate 322 and used in manufacturing a waveguide combiner, as described herein.

Overall, the present disclosure provides improved methods of fabricating and assembling waveguide combiners. The methods can produce waveguide combiners by bonding a first grating from a first donor substrate, e.g., silica, to a substrate, e.g., glass, thereby allowing for efficient waveguide processing. The present disclosure may allow for higher yields waveguide manufacturing due to the individualized production of the first grating. Additionally, the present disclosure may allow for the creation of curved waveguide devices with the use of specialized carrier substrates. For example, the present disclosure may allow for complex waveguide combiners and/or non-standard waveguide combiners to be formed, thereby allowing for unique waveguide combiner assembly architectures to be formed. Additionally, a reduction in manufacturing costs may be achieved by individualized repair processes, in which a first grating of a waveguide combiner may be repaired without the need to replace the entire waveguide combiner.

While the foregoing is directed to embodiments of the present disclosure, other and further embodiments of the disclosure may be devised without departing from the basic scope thereof, and the scope thereof is determined by the claims that follow.

What is claimed is:

1. A method of forming a waveguide combiner, comprising:
disposing a first grating comprising a first device structure over a first donor substrate; and
transferring the first grating from the first donor substrate to a waveguide substrate.

2. The method of claim 1, further comprising:
disposing a second grating comprising a second device structure over a second donor substrate; and
transferring the second grating from the second donor substrate to the waveguide substrate.

3. The method of claim 1, further comprising disposing a second grating comprising a second device structure over the waveguide substrate.

4. The method of claim 1, further comprising disposing a coating layer over the first grating.

5. The method of claim 1, wherein transferring the first grating from the first donor substrate to the waveguide substrate comprises transferring the first grating using a transfer substrate, wherein the transfer substrate comprises an adhesive layer.

6. The method of claim 1, further comprising:
disposing a third grating comprising a third device structure over a third donor substrate; and
transferring the third grating from the third donor substrate to the waveguide substrate.

7. A method of forming a waveguide combiner, comprising:
disposing a first coating layer over a first donor substrate;
disposing a first device structure over the first coating layer; and
transferring the first device structure to a waveguide substrate, wherein transferring the first device structure comprises inverting the first donor substrate and disposing the first device structure over the waveguide substrate.

8. The method of claim 7, wherein transferring the first device structure to the waveguide substrate further comprises disposing an adhesive layer between the first device structure and the waveguide substrate.

9. The method of claim 7, wherein transferring the first device structure to the waveguide substrate further comprises performing a treatment process on a surface of the waveguide substrate.

10. The method of claim 7, further comprising disposing an encapsulation layer over the first coating layer.

11. The method of claim 7, further comprising:
disposing a second coating layer over a second donor substrate;
disposing a second device structure over the second coating layer; and
transferring the second device structure to the waveguide substrate, wherein transferring the second device structure comprises inverting the second donor substrate and disposing the second device structure over the waveguide substrate.

12. The method of claim 11, wherein transferring the second device structure to the waveguide substrate further comprises disposing an adhesive layer between the second device structure and the waveguide substrate.

13. The method of claim 11, further comprising:
disposing a third coating layer over a third donor substrate;
disposing a third device structure over the third coating layer; and
transferring the third device structure to the waveguide substrate, wherein transferring the third device structure comprises inverting the third donor substrate and disposing the third device structure over the waveguide substrate.

14. The method of claim 13, wherein transferring the third device structure to the waveguide substrate further comprises performing a treatment process on a surface of the waveguide substrate.

15. The method of claim 13, wherein transferring the third device structure to the waveguide substrate further comprises disposing an adhesive layer between the third device structure and the waveguide substrate.

16. A waveguide combiner, comprising:
a substrate; and
a first grating disposed over the substrate, the first grating comprising:
a first device structure; and
a first coating layer disposed over the first device structure.

17. The waveguide combiner of claim 16, further comprising an encapsulation layer disposed over the first grating.

18. The waveguide combiner of claim 16, further comprising a second grating disposed over the substrate, the second grating comprising:
a second device structure; and
a second coating layer disposed over the second device structure.

19. The waveguide combiner of claim 16, further comprising a third grating disposed over the substrate, the third grating comprising:
a third device structure; and
a third coating layer disposed over the third device structure.

20. The waveguide combiner of claim 16, wherein the first coating layer is disposed between the first device structure and the substrate.
